(19) United States
(12) Patent Application Publication
(10) Pub. No.: US 2008/0009216 A1
(43) Pub. Date: Jan. 10, 2008

(54) Method for manufacturing field emitter

(75) Inventors: Yuan-Chao Yang, Beijing (CN); Liang Liu, Beijing (CN); Kai-Li Jiang, Beijing (CN); Shou-Shan Fan, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing City (CN); HON HAI Precision Industry Co., LTD, Tu-Cheng City (TW)

(21) Appl. No.: 11/588,086

(22) Filed: Oct. 26, 2006

(30) Foreign Application Priority Data
Jul. 7, 2006 (CN) 200610061558.6

(51) Int. Cl. H01J 9/04; H01J 9/12

(52) U.S. Cl. 445/50

(57) ABSTRACT

A method for manufacturing a field emitter, includes the steps of: providing a CNT yarn segment; attaching the CNT yarn segment to a heat conductor; and burning the CNT yarn segment thereby yielding a remaining portion of the CNT yarn segment for use as a field emitter. It is proper to manufacture a plurality of field emitters with essentially even field emission properties using the present method.

### TECHNICAL FIELD

The present invention generally relates to a method for manufacturing field emitters, which can achieve essentially even field emission.

### BACKGROUND

Since being discovered in 1991, CNTs have been synthesized by numerous methods such as laser vaporization, arc discharge, pyrolysis, plasma-enhanced chemical vapor deposition, and thermal chemical vapor deposition. CNT yarns can be made of CNTs as disclosed in U.S. Pat. No. 7,045,108 incorporated by reference thereto. The CNT yarns would enable macroscopic CNT devices and structures to be constructed.

CNT yarns can be also be utilized as field emission source because ends of CNT yarns have a good field emission property. However, different CNT yarns may have different field emission properties depending on differing CNT yarn end shapes. Different CNT yarns usually have quite different CNT yarn end shapes. Moreover, CNT yarn length is difficult to control. Therefore, production of multiple CNT yarns with similar field emission properties has proved problematic.

It is therefore desirable to find a new manufacturing method which can overcome the above mentioned problems.

### SUMMARY

In a preferred embodiment, a method for manufacturing a field emitter, includes the steps of: providing a CNT yarn segment; attaching the CNT yarn segment to a heat conductor; and burning the CNT yarn segment thereby yielding a remaining portion of the CNT yarn segment for use as a field emitter.

### BRIEF DESCRIPTION OF THE DRAWINGS

Many aspects of embodiments can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a scanning electron microscope (SEM) image of a first field emitter manufactured by the present method;

FIG. 2 is an SEM image of a second field emitter manufactured by the present method;

FIG. 3 is an SEM image of a third field emitter manufactured by the present method;

FIG. 4 is a field emission curve of the first field emitter of FIG. 1;

FIG. 5 is a field emission curve of the second field emitter of FIG. 2; and

FIG. 6 is a field emission curve of the third field emitter of FIG. 3.

### DETAILED DESCRIPTION OF THE EMBODIMENTS

Embodiments will now be described in detail below with reference to the drawings.

A method for manufacturing a field emitter includes the steps of:

1) providing a CNT yarn;

2) dividing the CNT yarn into several CNT yarn segments;

3) attaching a CNT yarn segment to a heat conductor; and

4) burning the CNT yarn segment thereby yielding a remaining portion of the CNT yarn segment for use as a field emitter.

In step 1, the CNT yarn can be fabricated using a method, as disclosed in U.S. Pat. No. 7,045,108 which is incorporated herein by reference. The method includes the steps of providing a flat and smooth substrate; depositing a catalyst on the substrate; positioning the substrate with the catalyst in a furnace; heating the furnace to a predetermined temperature; supplying a mixture of carbon containing gas and protecting gas into the furnace, maintaining a difference between the local temperature of the catalyst and the furnace temperature of above 50 degrees Centigrade (° C.); maintaining the partial pressure of the carbon containing gas at less than 0.2; growing a number of CNTs on the substrate such that a CNT array is formed on the substrate; and drawing out a bundle of CNTs from the CNT array in a manner such that a CNT yarn is formed.

In step 2, the CNT yarn can be divided using a mechanical method, or a non-mechanical method. Mechanical methods can include cutting using a pair of scissors or a knife. Non-mechanical methods can include cutting using a laser, or burning. There is no particular limitation on a length of each CNT yarn segment.

In step 3, the CNT yarn segment can be attached to the heat conductor using, for example, epoxy glue. The heat conductor is used as supporter and can be made of metal with a high heat conductivity and enough strength. The heat conductor can be, for example, a copper wire, or a copper stick. In the present embodiment, the heat conductor is a copper wire.

In step 4, the CNT segment is burned using a flame, for example, the flame of an alcohol lamp. The CNT segment can thus be burned evenly. A temperature of the flame can be in a range from 400° C. to 500° C. In this case, one part of the CNT yarn segment far away from the copper wire is burned down, but another part of the CNT yarn segment close to the copper wire is left due to a high heat conductivity of the CNT yarn segment. A length of a remainder portion of the CNT yarn segment after burning (hereinafter, refer to as the remainder portion) depends on following factors: oxidative atmosphere, temperature of flame, diameter of CNT yarn, material of the wire, and diameter of the wire.

In one embodiment, the length of the remainder portion and the factors are shown as follows:

| | | | | | length of the |
|---|---|---|---|---|---|
| | | | | | remainder |
| oxidative | temperature | diameter of CNT | material of | diameter of the | portion |
| atmosphere | of flame (° C.) | yarn (microns) | the wire | wire (microns) | (microns) |
| air | about 450 | about 50 | copper | about 600 | about 500 |

A plurality of field emitter can be obtained by repeating steps 3 and 4 consequently using CNT yarn segment in step 2. In step 3, it should be noted that each CNT yarn segment can be attached to a same heat conductor sequently, or attached to a plurality of roughly similar heat conductors respectively. In step 3, it should also be noted that the CNT yarn segments can be attached together to a heat conductor simultaneously. In this case, the CNT segments can be arranged evenly on the heat conductor.

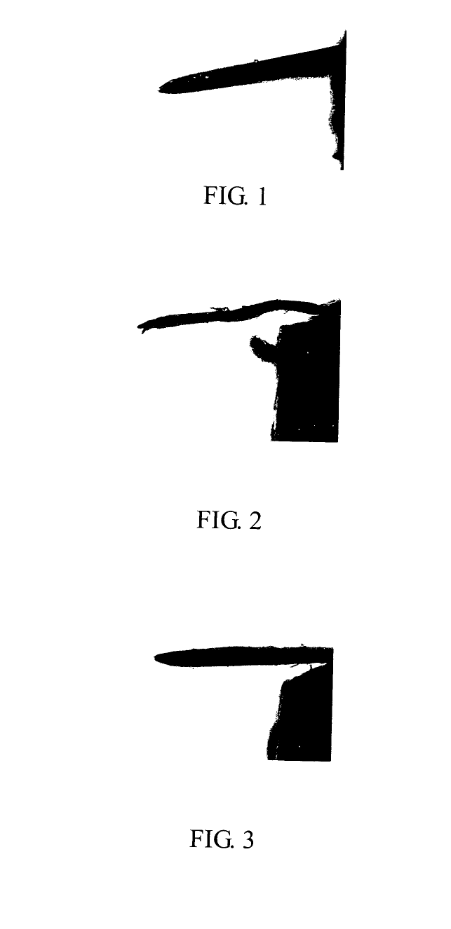

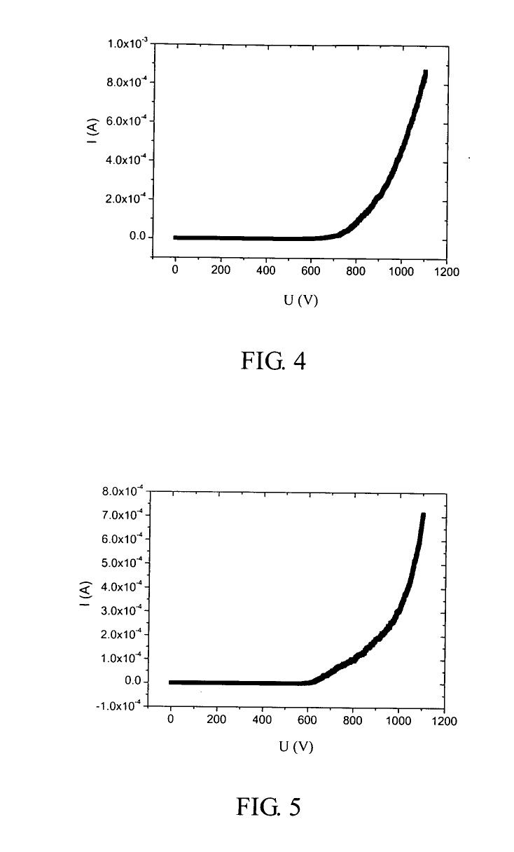

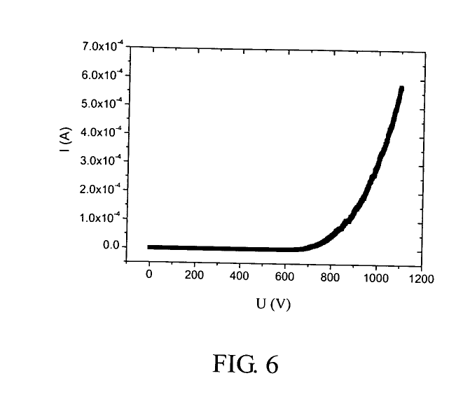

The three field emitters have a roughly same length and similar end-shape as seen in scanning electron microscope (SEM) pictures shown in FIGS. 1 to 3. Field emission curves of each field emitter are shown in FIGS. 4 to 6. In the curves, horizontal axes represent voltage (symbol U) in volts (V), and vertical axes represent current (symbol I) in amps (A). The three field emitters achieve a roughly same field emission property as seen from the charts.

It is therefore practical to manufacture a plurality of field emitters with substantially even field emission properties using the present method.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A method for manufacturing a field emitter, comprising the steps of:
providing a CNT yarn segment;
attaching the CNT yarn segment to a heat conductor; and
burning the CNT yarn segment thereby yielding a remaining portion of the CNT yarn segment for use as a field emitter.

2. The method as claimed as in claim 1, wherein the CNT yarn segment is made using a method comprising the steps of:
providing a CNT yarn; and
dividing the CNT yarn thereby yielding at least one CNT yarn segment.

3. The method as claimed as in claim 2, wherein the CNT yarn is obtained by a method comprising the steps of:
providing a CNT array; and
drawing out a bundle of CNTs from the CNT array in a manner such that a CNT yarn is formed.

4. The method as claimed as in claim 2, wherein the CNT yarn segment is cut from the CNT yarn using a tool selected from the group consisting of a knife and a scissor.

5. The method as claimed as in claim 2, wherein the CNT yarn segment is cut from the CNT yarn using a method selected from the group consisting of laser cutting and burning.

6. The method as claimed as in claim 1, wherein the CNT yarn segment is attached to the heat conductor using epoxy glue.

7. The method as claimed as in claim 1, wherein the heat conductor consists of copper.

8. The method as claimed as in claim 1, wherein the field emitter is obtained by burning the CNT yarn segment using an alcohol lamp.

9. The method as claimed as in claim 1, wherein the CNT yarn has a diameter of 50 microns, the heat conductor has a diameter of 600 microns, and the burning takes place in air using a flame with a temperature of 450° C.

10. The method as claimed as in claim 1, wherein a first end portion of the CNT yarn segment is attached to the heat conductor, and an opposite second end of the CNT yarn is burned off.
